(19) United States
(12) Patent Application Publication
(10) Pub. No.: US 2026/0190160 A1
(43) Pub. Date: Jul. 2, 2026

(54) CONTENTION FREE RANDOM ACCESS FOR INTER-CELL MULTIPLE TRANSMISSION AND RECEPTION POINT COMMUNICATION

(71) Applicant: QUALCOMM Incorporated, San Diego, CA (US)

(72) Inventors: Shaozhen GUO, Beijing (CN); Mostafa KHOSHNEVISAN, San Diego, CA (US)

(21) Appl. No.: 19/129,348

(22) PCT Filed: Jan. 31, 2023
(86) PCT No.: PCT/CN2023/073942

§ 371 Date: May 13, 2025

(51) Int. Cl. H04W 74/0838; H04L 5/00; H04W 52/24; H04W 72/23

(52) U.S. Cl. CPC H04W 74/0838; H04L 5/0053; H04W 52/247; H04W 72/23

(57) ABSTRACT

Various aspects of the present disclosure generally relate to wireless communication. In some aspects, a user equipment (UE) may receive a physical downlink control channel (PDCCH) order associated with a first control resource set (CORESET) pool index indicating a contention free random access (CFRA) configuration associated with a physical cell identifier (PCI). The UE may transmit a physical random access channel (PRACH) communication toward the PCI in accordance with the CFRA configuration. The UE may receive a random access response (RAR) communication associated with the first CORESET pool index or a second CORESET pool index different from the first CORESET pool index responsive to the PRACH communication. Numerous other aspects are described.

### FIELD OF THE DISCLOSURE

Aspects of the present disclosure generally relate to wireless communication and to techniques and apparatuses for contention free random access for inter-cell multiple transmission and reception point communication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a physical downlink control channel (PDCCH) order associated with a first control resource set (CORESET) pool index indicating a contention free random access (CFRA) configuration associated with a physical cell identifier (PCI). The method may include transmitting a physical random access channel (PRACH) communication toward the PCI in accordance with the CFRA configuration. The method may include receiving a random access response (RAR) communication associated with the first CORESET pool index or a second CORESET pool index different from the first CORESET pool index responsive to the PRACH communication.

Some aspects described herein relate to a method of wireless communication performed by a network node. The method may include outputting or configuring a PDCCH order indicating a CFRA configuration associated with a PCI for a PRACH communication. The method may include configuring a UE to receive a RAR communication associated with a first CORESET pool index or a second CORESET pool index different from the first CORESET pool index responsive to a PRACH communication.

Some aspects described herein relate to a UE for wireless communication. The user equipment may include a memory and one or more processors coupled to the memory. The one or more processors may be configured to receive a PDCCH order associated with a first CORESET pool index indicating a CFRA configuration associated with a PCI. The one or more processors may be configured to transmit a PRACH communication toward the PCI in accordance with the CFRA configuration. The one or more processors may be configured to receive a RAR communication associated with the first CORESET pool index or a second CORESET pool index different from the first CORESET pool index responsive to the PRACH communication.

Some aspects described herein relate to a network node for wireless communication. The network node may include a memory and one or more processors coupled to the memory. The one or more processors may be configured to output or configure a PDCCH order indicating a CFRA configuration associated with a PCI for a PRACH communication. The one or more processors may be configured to configure a UE to receive a RAR communication associated with a first CORESET pool index or a second CORESET pool index different from the first CORESET pool index responsive to a PRACH communication.

Some aspects described herein relate to a non-transitory computer-readable medium that stores a set of instructions for wireless communication by a UE. The set of instructions, when executed by one or more processors of the UE, may cause the UE to receive a PDCCH order associated with a first CORESET pool index indicating a CFRA configuration associated with a PCI. The set of instructions, when executed by one or more processors of the UE, may cause the UE to transmit a PRACH communication toward the PCI in accordance with the CFRA configuration. The set of instructions, when executed by one or more processors of the UE, may cause the UE to receive a RAR communication associated with the first CORESET pool index or a second CORESET pool index different from the first CORESET pool index responsive to the PRACH communication.

Some aspects described herein relate to a non-transitory computer-readable medium that stores a set of instructions for wireless communication by a network node. The set of instructions, when executed by one or more processors of the network node, may cause the network node to output or configure a PDCCH order indicating a CFRA configuration associated with a PCI for a PRACH communication. The set of instructions, when executed by one or more processors of the network node, may cause the network node to configure a UE to receive a RAR communication associated with a first CORESET pool index or a second CORESET pool index different from the first CORESET pool index responsive to a PRACH communication.

Some aspects described herein relate to an apparatus for wireless communication. The apparatus may include means for receiving a PDCCH order associated with a first CORESET pool index indicating a CFRA configuration associated with a PCI. The apparatus may include means for transmitting a PRACH communication toward the PCI in accordance with the CFRA configuration. The apparatus may include means for receiving a RAR communication associated with the first CORESET pool index or a second CORESET pool index different from the first CORESET pool index responsive to the PRACH communication.

Some aspects described herein relate to an apparatus for wireless communication. The apparatus may include means for outputting or configuring a PDCCH order indicating a CFRA configuration associated with a PCI for a PRACH communication. The apparatus may include means for configuring a UE to receive a RAR communication associated with a first CORESET pool index or a second CORESET pool index different from the first CORESET pool index responsive to a PRACH communication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed RAN, in accordance with the present disclosure.

FIG. 5 is a diagram illustrating an example of multiple transmission and reception point (mTRP) communication, in accordance with the present disclosure.

FIG. 6 is a diagram illustrating an example of TRP differentiation at a UE based at least in part on a control resource set pool index, in accordance with the present disclosure.

FIG. 7 is a diagram illustrating an example associated with contention free random access for inter-cell mTRP communication, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

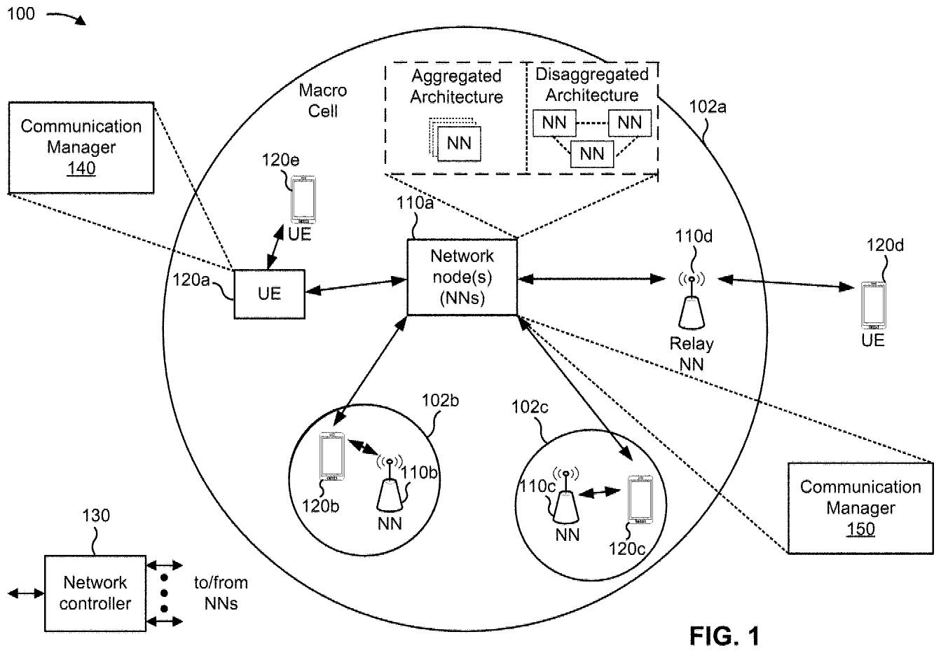

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a physical downlink control channel (PDCCH) order associated with a first control resource set (CORESET) pool index indicating a contention free random access (CFRA) configuration associated with a physical cell identifier (PCI); transmit a physical random access channel (PRACH) communication toward the PCI in accordance with the CFRA configuration; and receive a random access response (RAR) communication associated with the first CORESET pool index or a second CORESET pool index different from the first CORESET pool index responsive to the PRACH communication. Additionally, or alternatively, the communication manager 140 may perform one or more other operations described herein.

In some aspects, the network node 110 may include a communication manager 150. As described in more detail elsewhere herein, the communication manager 150 may output or configuring a PDCCH order indicating a CFRA configuration associated with a PCI for a PRACH communication; and configure a UE to receive a RAR communication associated with a first CORESET pool index or a second CORESET pool index different from the first CORESET pool index responsive to a PRACH communication. Additionally, or alternatively, the communication manager 150 may perform one or more other operations described herein.

As indicated above, FIG. 1 is provided as an example. Other examples may differ from what is described with regard to FIG. 1.

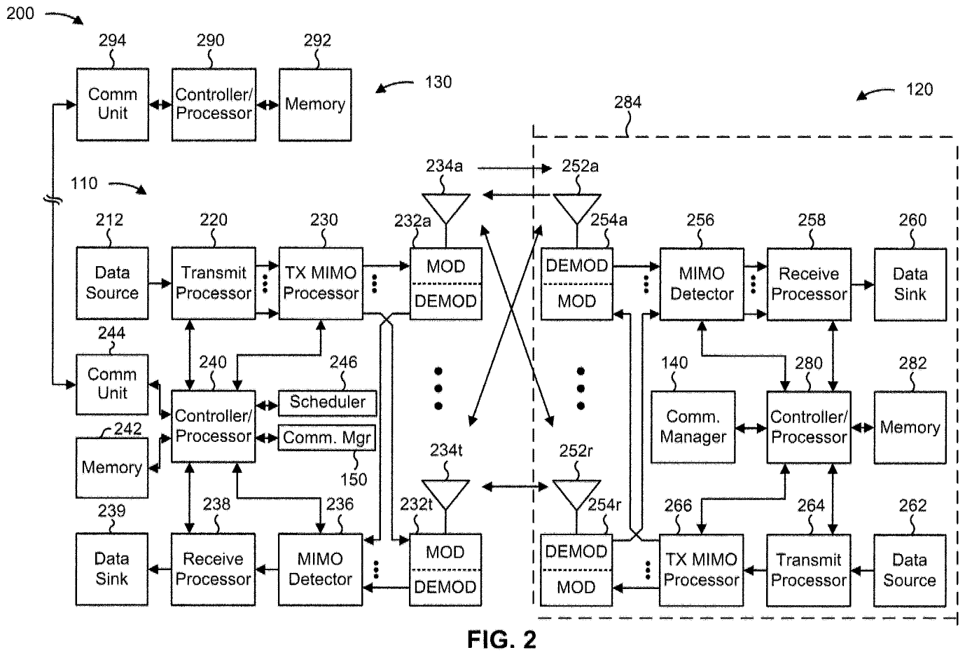

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

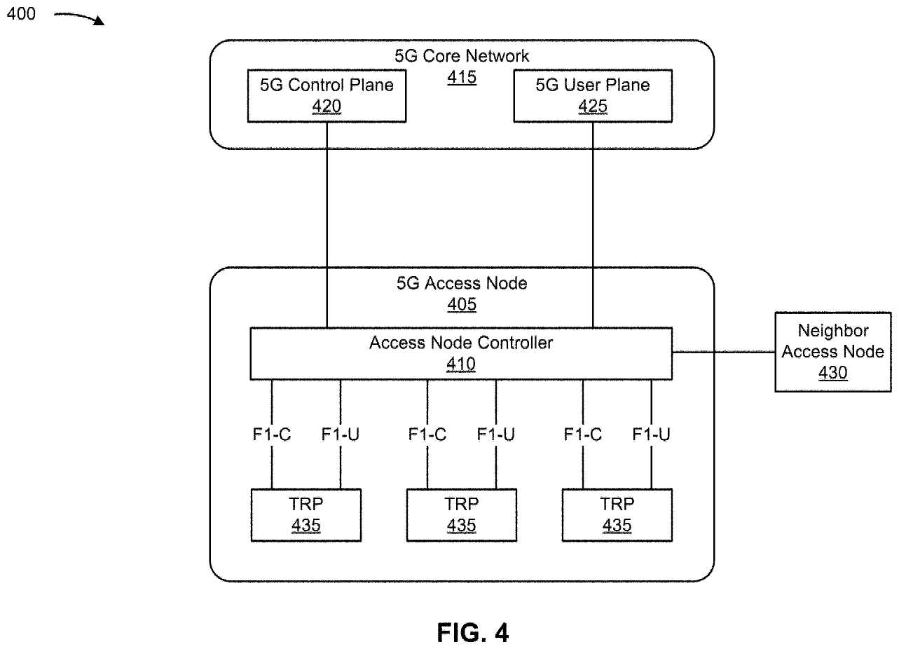

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

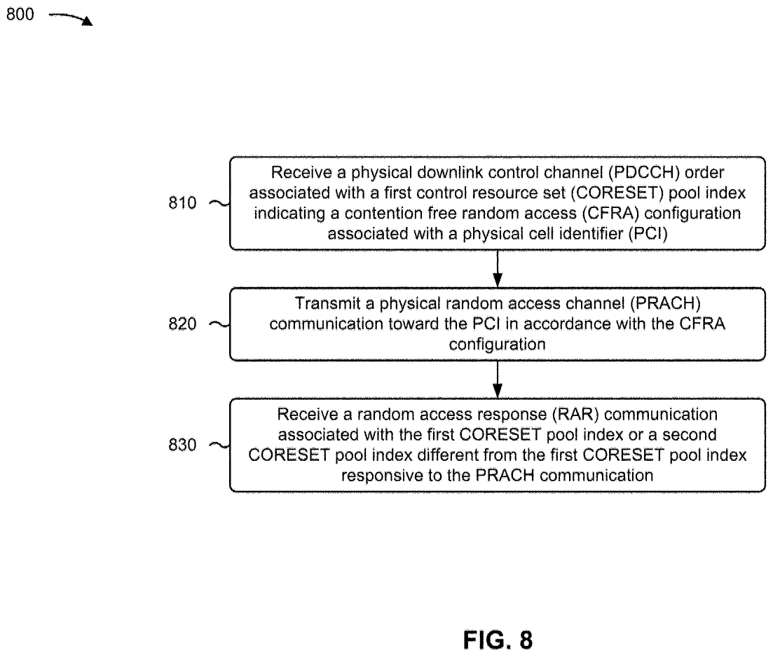

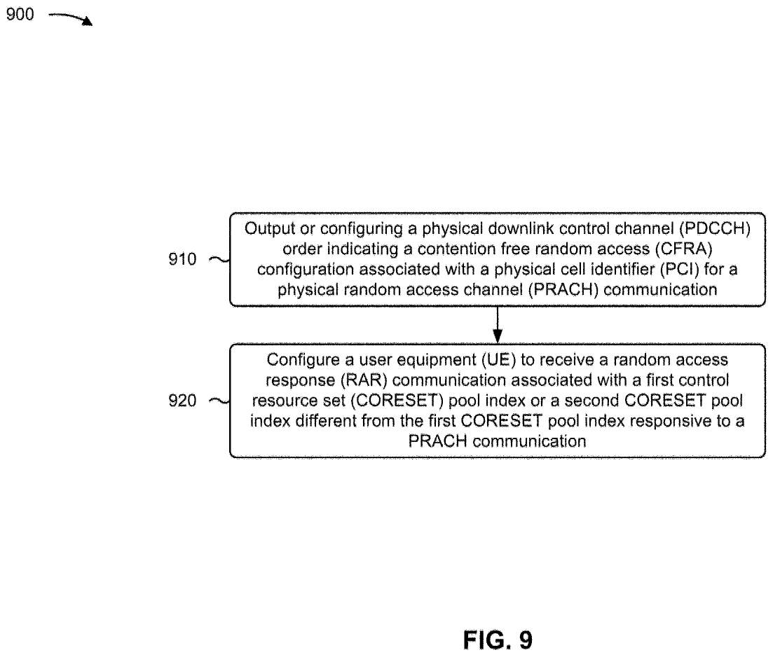

The controller/processor 240 of the network node 110, the controller/processor 280 of the UE 120, and/or any other component(s) of FIG. 2 may perform one or more techniques associated with CFRA for multiple transmission and reception point (mTRP) communication, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving a PDCCH order associated with a first CORESET pool index indicating a CFRA configuration associated with a PCI; means for transmitting a PRACH communication toward the PCI in accordance with the CFRA configuration; and/or means for receiving a RAR communication associated with the first CORESET pool index or a second CORESET pool index different from the first CORESET pool index responsive to the PRACH communication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for outputting or configuring a PDCCH order indicating a CFRA configuration associated with a PCI for a PRACH communication; and/or means for configuring a UE to receive a RAR communication associated with a first CORESET pool index or a second CORESET pool index different from the first CORESET pool index responsive to a PRACH communication. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

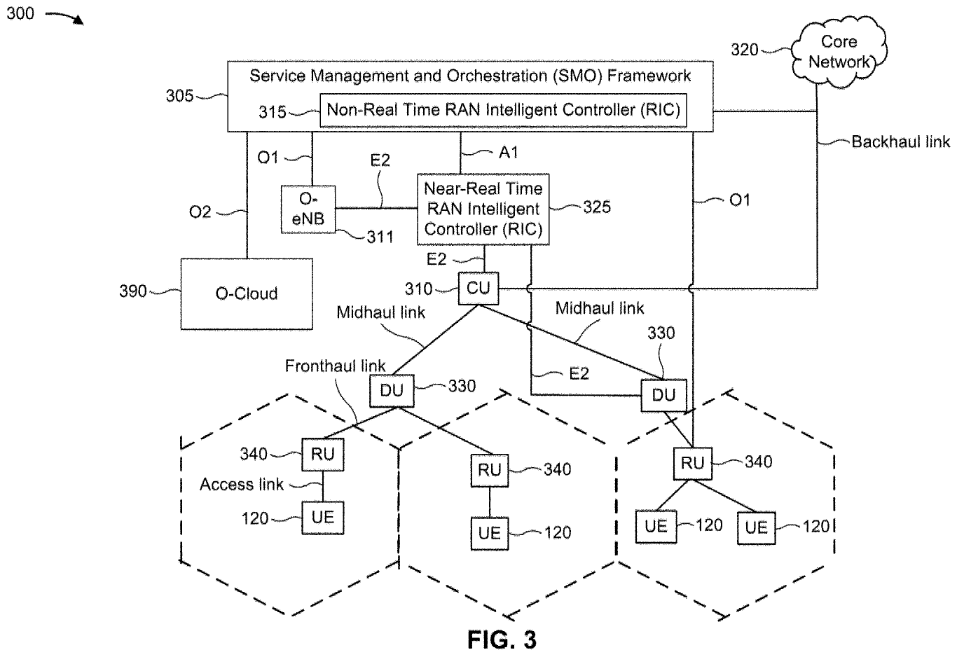

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

In some aspects, the logical architecture of the distributed RAN 400 described in association with FIG. 4 may be used to support TA indication in an RAR for inter-cell multi-TRP communication, as described herein.

As indicated above, FIG. 4 is provided as an example. Other examples may differ from what was described with regard to FIG. 4.

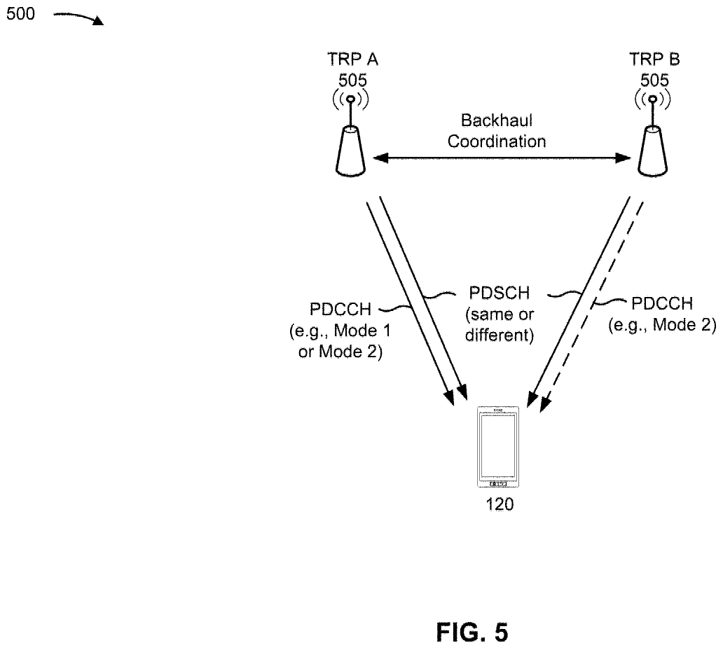

FIG. 5 is a diagram illustrating an example 500 of multi-TRP communication (sometimes referred to as multi-panel communication or mTRP communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single PDCCH may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state). For uplink multi-DCI multi-TRP communication, multiple PDCCHs may be used to schedule uplink data communications for multiple corresponding PUSCHs (e.g., one PDCCH for each PUSCH). In this case, a first PDCCH may schedule a first codeword to be transmitted to a first TRP 505, and a second PDCCH may schedule a second codeword to be transmitted to a second TRP 505. For uplink multi-DCI multi-TRP, multiple TAs may be used for PUSCHs towards multiple TRPs considering the propagation delay to different TRPs may be different.

In some aspects, the techniques and apparatuses associated with TA indication in an RAR for inter-cell multi-TRP communication described herein can be used in conjunction with multi-TRP communication as described in association with FIG. 5.

As indicated above, FIG. 5 is provided as an example. Other examples may differ from what is described with respect to FIG. 5.

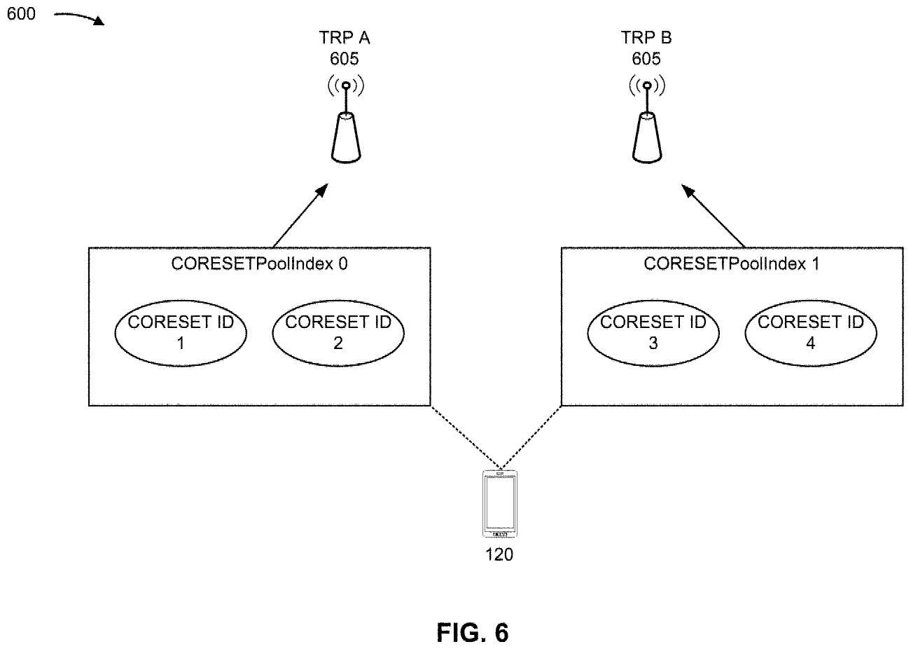

FIG. 6 is a diagram illustrating an example 600 of TRP differentiation at a UE based at least in part on a CORESET pool index, in accordance with the present disclosure. In some aspects, a CORESET pool index (or CORESETPoolIndex) value may be used by a UE (e.g., a UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (e.g., up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) may be associated with CORESET pool index 0 and a second TRP 605 (TRP B) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

In some aspects, TRP differentiation at a UE based at least in part on a CORESET pool index can be utilized in conjunction with the techniques and apparatuses for TA indication in an RAR for inter-cell multi-TRP communication as described herein.

As indicated above, FIG. 6 is provided as an example. Other examples may differ from what is described with respect to FIG. 6.

A UE may attempt a CFRA procedure with a network node, such as a gNB, for various purposes such as timing advance (TA) acquisition, synchronizing network communications, beam failure recovery, handling system information requests, handovers to new network nodes, etc. In a CFRA procedure, the UE is assigned a preamble, which is included with random access communications to the network node.

The UE may not be configured for CFRA procedures when attempting to communicate with secondary cells (SCells) or special cells (SpCells) in inter-cell mTRP implementations. For example, for CFRA on an SpCell, the UE may assume the DMRS ports of the RAR PDCCH/PDSCH and the DMRS ports of the PDCCH order are QCLed. That assumption does not apply to CFRA on an SCell, however. For PRACH power control, the UE may assume the path loss reference signal (PL-RS) and reference signal power are based on a downlink reference signal (DL-RS) QCLed with the DMRS of the PDCCH order. Such QCL relationship may not be valid in certain inter-cell mTRP implementations. In another example, the UE cannot receive type 1 common search space (CSS) signaling from network node with an additional active PCI. Accordingly, based on traditional QCL assumptions, the UE may not be able to engage in a CFRA procedure in a mTRP scenario involving an SCell, an SpCell, or both, associated with certain PCIs. For instance, one or more of the assumptions of the UE may be incorrect if the TRPs are associated with different types of PCIs. In one possible scenario, one or more assumptions of the UE may be inapplicable if PDCCH order is associated with one TRP and RAR PDCCH/PDSCH is associated with another TRP. In one possible scenario, one or more assumptions of the UE may be inapplicable if PDCCH order is associated with one TRP and PRACH is transmitted towards another TRP.

The table below lists example outcomes of a CFRA procedure triggered by a PDCCH order. In the table, X denotes the PDCCH order, Y denotes the PRACH, and Z denotes the RAR (PDDCH in type 1 CSS and RAR PDSCH). The table summarizes different possibilities for inter-cell mTRP in the case of SpCell, where the CORESET pool index 0 (TRP0) is associated with a serving PCI (PCI0) and CORESET pool index 1 (TRP1) is associated with PCI1 (active additional PCI). The term “NIB” refers to “non-ideal backhaul.” Rule 1 may refer to a situation where, for CFRA on an SpCell, the DMRS ports of the RAR PDCCH/PDSCH and the DMRS ports of the PDCCH order are QCLed. Rule 1 may be inapplicable to CFRA on an SCell. Rule 2 may refer to a situation where, for PRACH power control, the path loss reference signal and referenceSignalPower are based on the downlink reference signal QCLed with the DMRS of the PDCCH order. Rule 3 may refer to a situation where a type 1 CSS cannot be from an additional PCI. Consideration 1 refers to a situation where the NIB can delay PRACH triggering (cross-TRP PDCCH order). Consideration 2 refers to a situation where the NIB can delay RAR (RAR from a different TRP than the one receiving the RACH. As shown in the table below, when the PRACH is toward a serving cell PCI (TRP0), Case 1 is the only case where Rules 1, 2, and 3 are satisfied. When the PRACH is toward an inactive additional PCI (PCI2), Case 1 has the highest number of rules satisfied (Rules 1 and 3), giving Case 1 an advantage over the other Cases listed.

TABLE 1

| | | | | | Consid- | Consid- |
|---|---|---|---|---|---|---|
| PRACH | X −> | Rule | Rule | Rule | eration | eration |
| toward | Y −> Z | 1 | 2 | 3 | 1 | 2 |
| PCI0 | Case 1: | Ok | Ok | Ok | No | No |
| (serving | TRP0 −> | | | | | |
| PCI) | PCI0 −> | | | | | |
| | TRP0 | | | | | |
| | Case 2: | Vio- | Ok | Vio- | No | Yes |
| | TRP0 −> | lated | | lated | | |
| | PCI0 −> | | | | | |
| | TRP1 | | | | | |
| | Case 3: | Vio- | Vio- | Ok | Yes | No |
| | TRP1 −> | lated | lated | | | |
| | PCI0 −> | | | | | |
| | TRP0 | | | | | |
| | Case 4: | Ok | Vio- | Vio- | Yes | Yes |
| | TRP1 −> | | lated | lated | | |
| | PCI0 −> | | | | | |
| | TRP1 | | | | | |
| PCI1 | Case 1: | Ok | Vio- | Ok | Yes | Yes |
| (active | TRP0 −> | | lated | | | |
| additional | PCI1 −> | | | | | |
| PCI) | TRP0 | | | | | |
| | Case 2: | Vio- | Vio- | Vio- | Yes | No |
| | TRP0 −> | lated | lated | lated | | |
| | PCI1 −> | | | | | |
| | TRP1 | | | | | |
| | Case 3: | Vio- | Ok | Ok | No | Yes |
| | TRP1 −> | lated | | | | |
| | PCI1 −> | | | | | |
| | TRP0 | | | | | |
| | Case 4: | Ok | Ok | Vio- | No | No |
| | TRP1 −> | | | lated | | |
| | PCI1 −> | | | | | |
| | TRP1 | | | | | |
| PCI2 | Case 1: | Ok | Vio- | Ok | Yes | Yes |
| (inactive | TRP0 −> | | lated | | | |
| additional | PCI2 −> | | | | | |
| PCI) | TRP0 | | | | | |
| | Case 2: | Vio- | Vio- | Vio- | Yes | Yes |
| | TRP0 −> | lated | lated | lated | | |
| | PCI2 −> | | | | | |
| | TRP1 | | | | | |
| | Case 3: | Vio- | Vio- | Ok | Yes | Yes |
| | TRP1 −> | lated | lated | | | |
| | PCI2 −> | | | | | |
| | TRP0 | | | | | |
| | Case 4: | Ok | Vio- | Vio- | Yes | Yes |
| | TRP1 −> | | lated | lated | | |
| | PCI2 −> | | | | | |
| | TRP1 | | | | | |

Table 1 illustrates further an example where the PRACH is toward an active additional PCI (PCI1). None of the cases illustrated have a clear advantage. Cases 1, 3, and 4 each satisfy two rules (Rules 1 and 3, Rules 2 and 3, and Rules 1 and 2, respectively). If violating Rule 3 is permissible, Case 4 may be acceptable. Otherwise, Case 3 may be acceptable. On the other hand, if violating Rule 2 is permissible since Rule 2 is already violated for the inactive PCI (PCI2), Case 1 may be acceptable.

For PRACH on an SCell, the following scenarios may be considered. In one scenario, a PCell may be configured with the same two TRPs (TRP0 and TRP1) with multi-DCI based mTRP. In that case, the column Rule 1 from table 1 can be ignored. In another scenario, the PCell may not be configured with a CORESET pool index or may be configured with the CORESET pool index 0 (i.e., the PCell is not a multi-DCI mTRP).

Referring now to Table 2 analyzing situations where a CFRA procedure is triggered by a PDCCH order, where X is the PDCCH order, Y is the PRACH, and Z is the RAR (PDCCH in type 1 CSS and RAR PDSCH). In Table 2, different possibilities for inter-cell mTRP in the case of an SCell where CORESET pool index 0 (TRP0) is associated with a serving PCI (PCI0), CORESET pool index 1 (TRP1) is associated with PCI1 (active additional PCI) for both SCell and PCell. Conditions 1 and 2 are the same as in Table 1.

TABLE 2

| | X (Scell)−>Y | | | | |
|---|---|---|---|---|---|
| | (Scell)−>Z | | | | |
| PRACH toward | (Pcell) | Rule 2 | Rule 3 | Condition 1 | Condition 2 |
| PCI0 (serving PCI) | Case 1: TRP0 −> | Ok | Ok | No | No |
| | PCI0 −> TRP0 | | | | |
| | Case 2: TRP0 −> | Ok | Violated | No | Yes |
| | PCI0 −> TRP1 | | | | |
| | Case 3: TRP1 −> | Violated | Ok | Yes | No |
| | PCI0 −> TRP0 | | | | |
| | Case 4: TRP1 −> | Violated | Violated | Yes | Yes |
| | PCI0 −> TRP1 | | | | |
| PCI1 (active | Case 1: TRP0 −> | Violated | Ok | Yes | Yes |
| additional PCI) | PCI1 −> TRP0 | | | | |
| | Case 2: TRP0 −> | Violated | Violated | Yes | No |
| | PCI1 −> TRP1 | | | | |
| | Case 3: TRP1 −> | Ok | Ok | No | Yes |
| | PCI1 −> TRP0 | | | | |
| | Case 4: TRP1 −> | Ok | Violated | No | No |
| | PCI1 −> TRP1 | | | | |
| PCI2 (inactive | Case 1: TRP0 −> | Violated | Ok | Yes | Yes |
| additional PCI) | PCI2 −> TRP0 | | | | |
| | Case 2: TRP0 −> | Violated | Violated | Yes | Yes |
| | PCI2 −> TRP1 | | | | |
| | Case 3: TRP1 −> | Violated | Ok | Yes | Yes |
| | PCI2 −> TRP0 | | | | |
| | Case 4: TRP1 −> | Violated | Violated | Yes | Yes |
| | PCI2 −> TRP1 | | | | |

When the PRACH is toward a serving PCI (PCI0), Case 1 presents the only situation where both Rules 2 and 3 are satisfied. When the PRACH is toward an active additional PCI (PCI1), Case 3 presents the only situation where both Rules 2 and 3 are satisfied. When the PRACH is toward an inactive additional PCI (PCI2), Cases 1 and 3 each satisfy Rule 3, and are the only situations where at least one rule is satisfied.

Table 3 below summarizes situations where inter-cell mTRP in the case of an SCell where CORESET pool index 0 (TRP0) is associated with a serving PCI (PCI0), CORESET pool index 1 (TRP1) is associated with PCI1 (active additional PCI) for an SCell. The Pcell may not be configured with a CORESET pool index (or may be configured with the CORESET pool index 0). In this case, the RAR may be transmitted from the serving PCI and thus Rule 3 can be ignored.

TABLE 3

| | X (Scell)−>Y | | | |
|---|---|---|---|---|
| PRACH toward | (Scell)−>Z (Pcell) | Rule 2 | Condition 1 | Condition 2 |
| PCI0 (serving | Case 1: TRP0 −> PCI0 −> Pcell | Ok | No | No |
| PCI) | (TRP0) | | | |
| | Case 3: TRP1 −> PCI0 −> Pcell | Violated | Yes | No |
| | (TRP0) | | | |
| PCI1 (active | Case 1: TRP0 −> PCI1 −> Pcell | Violated | Yes | Yes |
| additional PCI) | (TRP0) | | | |
| | Case 3: TRP1 −> PCI1 −> Pcell | Ok | No | Yes |
| | (TRP0) | | | |
| PCI2 (inactive | Case 1: TRP0 −> PCI2 −> Pcell | Violated | Yes | Yes |
| additional PCI) | (TRP0) | | | |
| | Case 3: TRP1 −> PCI2 −> Pcell | Violated | Yes | Yes |
| | (TRP0) | | | |

When the PRACH is toward a serving PCI (PCI0), Case 1 presents the only situation where Rule 2 is satisfied. When the PRACH is toward an active additional PCI (PCI1), Case 3 presents the only situation where Rule 2 is satisfied. If the PRACH toward an inactive additional PCI (PCI2) is to be supported, Rule 2 cannot be satisfied. Accordingly, Cases 1 and 3 may be acceptable even though Rule 2 cannot be satisfied.

Some techniques and apparatuses described herein enable receiving a PDCCH order associated with a first CORESET pool index indicating a CFRA configuration associated with a PCI; transmitting a PRACH communication toward the PCI in accordance with the CFRA configuration; and receiving a RAR communication associated with the first CORESET pool index or a second CORESET pool index different from the first CORESET pool index responsive to the PRACH communication. As a result, the UE can be configured to communicate with multiple TRPs (each indicated by a CORESET pool index) during the CFRA procedure. For example, the UE can be configured to receive the RAR communication from a different TRP than the TRP that received the PRACH communication even in instances where the TRPs are associated with different PCIs.

Some techniques and apparatuses described herein enable outputting or configuring a PDCCH order indicating a CFRA configuration associated with a PCI for a PRACH communication; and configuring a UE to receive a RAR communication associated with a first CORESET pool index or a second CORESET pool index different from the first CORESET pool index responsive to a PRACH communication. As a result, the network node can configure the UE to communicate with multiple TRPs during the CFRA procedure, regardless of the PCI associated with the TRPs.

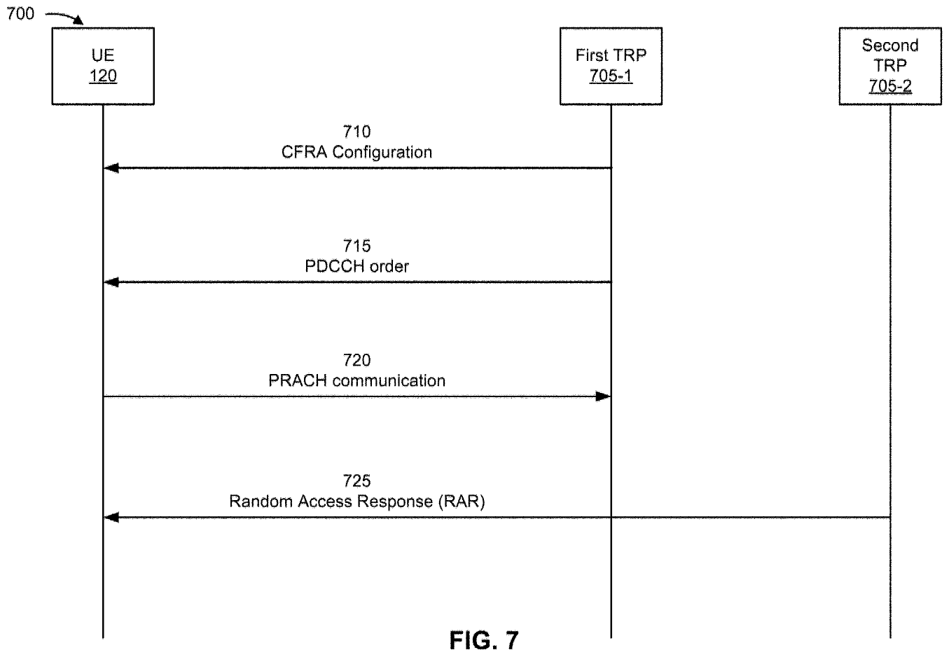

FIG. 7 is a diagram illustrating an example 700 associated with CFRA for inter-cell mTRP communication, in accordance with the present disclosure. As shown in FIG. 7, multiple TRPs (shown as TRP 705-1 and 705-2) and a UE 120 may communicate with one another.

As shown by reference number 710, the first TRP (e.g., TRP 705-1), having a first CORESET pool index, may output, and the UE may receive, a CFRA configuration based, at least in part, on whether the PCI associated with the first TRP and/or a second TRP (e.g., TRP 705-2) is a serving PCI, an active additional PCI, or an inactive additional PCI. The UE may be configured to operate according to the CFRA configuration.

As shown by reference number 715, the first TRP may transmit a PDCCH order to the UE. The PDCCH order may initiate a CFRA procedure between the UE, the first TRP, and a second TRP (e.g., TRP 705-2), having a second CORESET pool index different from the first CORESET pool index, according to the CFRA configuration. The first TRP or second TRP may be associated with a PCI, which may be a serving PCI, an active additional PCI, or an inactive additional PCI. In some aspects, the PCI associated with the first TRP is different from the PCI associated with the second TRP.

As shown by reference number 720, the UE may transmit, and the first TRP may receive, a PRACH communication. Alternatively, in some aspects, the UE may transmit, and the second TRP may receive, a PRACH communication. In some aspects, the PRACH communication is transmitted by the UE on an SpCell. In some aspects, the PRACH communication is transmitted by the UE on an SCell. The UE may transmit the PRACH communication according to the CFRA configuration. For example, the CFRA configuration may cause the UE to transmit the PRACH communication according to the CORESET pool index and/or PCI associated with the first TRP, the second TRP, or both. In some aspects, the PDCCH order is associated with the first CORESET pool index that triggers the PRACH communication as a result of the PCI being a serving PCI associated with the first CORESET pool index. In some aspects, the PDCCH order is associated with the first CORESET pool index that triggers the PRACH communication as a result of the PCI being an active additional PCI associated with the first CORESET pool index or the second CORESET pool index. In some aspects, whether the PDCCH order associated with the first CORESET pool index can trigger a PRACH communication towards an active additional PCI associated with a second CORESET pool index is conditioned on whether or not the PRACH for an inactive additional PCI is supported. In some aspects, whether the PDCCH order associated with the first CORESET pool index can trigger a PRACH communication towards an active additional PCI associated with a second CORESET pool index is configured by RRC. In some aspects, the PDCCH order is associated with the first CORESET pool index that triggers the PRACH communication as a result of the PCI being an inactive additional PCI.

The following aspects may apply to CFRA procedures on SpCells or SCells. In some aspects, the PDCCH order is associated with the first CORESET pool index that triggers the PRACH communication toward an active additional PCI associated with the second CORESET pool index, and a transmission power of the PRACH communication is determined based, at least in part, on a downlink reference signal of an active transmission configuration indication state having a lowest identification associated with the second CORESET pool index. In some aspects, the PDCCH order is associated with the first CORESET pool index that triggers the PRACH communication toward an active additional PCI associated with the second CORESET pool index, and the transmission power of PRACH communication is determined based, at least in part, on a downlink reference signal quasi co-located with a CORESET having the lowest CORESET ID among the CORESETs associated with the second CORESET pool index. In some aspects, the PDCCH order is associated with the first CORESET pool index that triggers the PRACH communication toward an active additional PCI associated with the second CORESET pool index, and the transmission power of PRACH communication is determined based, at least in part, on a latest indicated transmission control indication state associated with the second CORESET pool index. In some aspects, the PDCCH order is associated with the first CORESET pool index that triggers the PRACH communication toward an active additional PCI associated with the second CORESET pool index, and the transmission power of the PRACH communication is determined based, at least in part, on a path loss reference signal for a physical uplink control channel (PUCCH) resource having a lowest identification associated with the second CORESET pool index. In some aspects, the PDCCH order is associated with the first CORESET pool index that triggers the PRACH communication toward an active additional PCI associated with the second CORESET pool index, and the transmission power of the PRACH communication is determined based, at least in part, on a synchronization signal block associated with the PRACH communication wherein the synchronization signal block (SSB) is indicated by an SSB index field in the PDCCH order. In some aspects, the PDCCH order is associated with the first CORESET pool index that triggers the PRACH communication toward an active additional PCI associated with the second CORESET pool index, and a transmission power of the PRACH communication is determined based, at least in part, on a downlink reference signal that is quasi co-located with a synchronization signal block associated with the PRACH communication and indicated by an SSB index field in the PDCCH order. These aspects may be applied when the active additional PCI is associated with the second CORESET pool index. In some aspects, the aspects above may be configured by RRC signaling. In some aspects, the aspects above may be applied when a cross-TRP PRACH communication toward an active additional PCI is enabled by RRC signaling. In some aspects, the aspects above may be applied when a cross-TRP PRACH communication toward an active additional PCI is enabled by RRC signaling and the active additional PCI is associated with the second CORESET pool index. In some aspects, the aspects above may be applied when the PRACH toward an inactive additional PCI is enabled. In some aspects, the aspects above may be applied when the PRACH toward an inactive additional PCI is enabled and the active additional PCI is associated with the second CORESET pool index. In some aspects, the aspects above may be applied when the PRACH is transmitted toward an active additional PCI. In some aspects, the aspects above may be applied when the PRACH is transmitted toward an active additional PCI and the active additional PCI is associated with the second CORESET pool index.

In some aspects, the PDCCH order is associated with the first CORESET pool index that triggers the PRACH communication toward an inactive additional PCI, and the transmission power of the PRACH communication is determined based, at least in part, on a synchronization signal block configured for a layer 1 reference signal received power measurement and associated with the inactive additional PCI. In some aspects, the PDCCH order is associated with the first CORESET pool index that triggers the PRACH communication toward an inactive additional PCI, and the transmission power of the PRACH communication is determined based, at least in part, on an SSB associated with the PRACH communication and indicated by the SSB index field in the PDCCH order. In some aspects, the PDCCH order is associated with the first CORESET pool index that triggers the PRACH communication toward an inactive additional PCI, and the transmission power of the PRACH communication is determined based, at least in part, on a downlink reference signal that is quasi co-located with an SSB associated with the PRACH communication and indicated by an SSB index field in the PDCCH order. In some aspects, the PDCCH order is associated with the first CORESET pool index that triggers the PRACH communication toward an inactive additional PCI, and the transmission power of the PRACH communication is determined based, at least in part, on a downlink reference signal with an additional offset. In that aspect, the downlink reference signal is quasi co-located with a demodulation reference signal of the PDCCH order.

In some aspects, the PDCCH order is associated with the first CORESET pool index that triggers the PRACH communication toward an active additional PCI, and the CFRA configuration configures the UE to monitor the RAR communication from a serving PCI associated with the second CORESET pool index. In that aspect, the CFRA configuration further configures the UE to determine DMRS antenna port QCL properties for the PDCCH scrambled by RA-RNTI or a PDSCH communication scheduled by the PDCCH scrambled by RA-RNTI. The DMRS antenna port QCL properties may be based, at least in part, on a DL-RS of an active TCI state of the CORESET with a lowest ID among CORESETs associated with the second CORESET pool index; the DL-RS of the active TCI state with the lowest TCI state ID associated with the second CORESET Pool index; or the DL-RS of a latest indicated TCI state associated with the second CORESET pool index.

As shown by reference number 725, the second TRP may output, and the UE may receive, the RAR communication. Alternatively, in some aspects, the first TRP may output, and the UE may receive, the RAR communication. As discussed above, the second TRP may have a second CORESET pool index, different from the first CORESET pool index. In some aspects, by applying the CFRA configuration, the UE may receive and process the RAR from the second TRP despite the CFRA procedure being initiated from the first TRP. In some aspects, the RAR communication includes DCI scrambled by a random access (RA) radio network temporary identifier (RNTI) (RA-RNTI). In some aspects, such as when the PCI is an active additional PCI, the PRACH communication is triggered by the PDCCH order, and the PDCCH order is associated with the first CORESET pool index, the RAR communication may be associated with the second CORESET pool index.

For PRACH on the SpCell, in some aspects, the CFRA configuration may configure the UE to identify an error case when the PDCCH order associated with the first CORESET pool index indicates the PRACH communication toward one of an active additional PCI associated with the second CORESET pool index or an inactive additional PCI, denoted as behavior 1. In some aspects, the CFRA configuration prohibits the UE from monitoring of PDCCH candidates for a type-1 PDCCH common search space when an active TCI state for a CORESET associated with the type-1 PDCCH common search space is not associated with a serving PCI, denoted as behavior 2. In some aspects, the CFRA configuration configures the UE to identify an error case when the PDCCH order is associated with the first CORESET pool index and the DCI scrambled by RA-RNTI is associated with the second CORESET pool index different from the first CORESET pool index, denoted as behavior 3. In some aspects, behaviors 1, 2 and 3 may be applied when the PRACH is transmitted towards a serving PCI. In some aspects, both behaviors 2 and 3 may be applied when the PRACH is transmitted towards inactive additional PCI. In this case, the UE may be allowed to receive a PDCCH order associated with a first CORESET pool index to trigger a PRACH transmission towards an inactive additional PCI. In some aspects, both behaviors 1 and 2 may be applied when the PRACH is transmitted towards an active additional PCI. In this case, UE may be allowed to receive a RAR PDCCH associated with a second CORESET pool index in response to a PRACH triggered by a PDCCH order associated with a first CORESET pool index value. In some aspects, both behavior 2 and behavior 3 may be applied when the PRACH is transmitted towards an active additional PCI. In this case, UE is allowed to receive a PDCCH order associated with a first CORESET pool index to trigger a PRACH towards an active additional PCI associated with a second CORESET pool index. In some aspects, both behavior 1 and behavior 3 may be applied when the PRACH is transmitted towards an active additional PCI. In this case, the UE may be allowed to monitor PDCCH candidates for a type 1 PDCCH common search space set when an active TCI state for a corresponding CORESET is associated with an active additional PCI.

For PRACH on an Scell, in some aspects, the CFRA configuration configures the UE to receive the PDCCH order associated with a CORESET pool index to trigger the PRACH communication toward an inactive additional PCI. Additionally or alternatively, the CFRA configuration may configure the UE to ignore PDCCH candidates for a type 1 PDCCH common search space set when an active TCI state for a corresponding CORESET pool index is associated with an active additional PCI.

As a result, the UE can be configured to communicate with multiple TRPs (each indicated by a CORESET pool index) during the CFRA procedure. For example, the UE can be configured to receive the RAR communication from a different TRP than the TRP that received the PRACH communication even in instances where the TRPs are associated with different PCIs.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with CFRA for inter-cell mTRP communication.

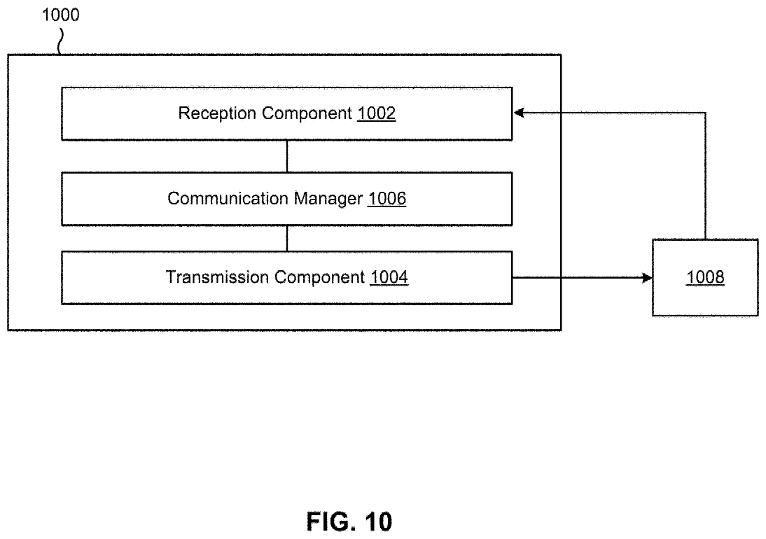

As shown in FIG. 8, in some aspects, process 800 may include receiving a PDCCH order associated with a first CORESET pool index indicating a CFRA configuration associated with a PCI (block 810). For example, the UE (e.g., using reception component 1002 and/or communication manager 1006, depicted in FIG. 10) may receive a PDCCH order associated with a first CORESET pool index indicating a CFRA configuration associated with a PCI, as described above in connection with FIGS. 4-7.

As further shown in FIG. 8, in some aspects, process 800 may include transmitting a PRACH communication toward the PCI in accordance with the CFRA configuration (block 820). For example, the UE (e.g., using transmission component 1004 and/or communication manager 1006, depicted in FIG. 10) may transmit a PRACH communication toward the PCI in accordance with the CFRA configuration, as described above in connection with FIGS. 4-7.

As further shown in FIG. 8, in some aspects, process 800 may include receiving a RAR communication associated with the first CORESET pool index or a second CORESET pool index different from the first CORESET pool index responsive to the PRACH communication (block 830). For example, the UE (e.g., using reception component 1002 and/or communication manager 1006, depicted in FIG. 10) may receive a RAR communication associated with the first CORESET pool index or a second CORESET pool index different from the first CORESET pool index responsive to the PRACH communication, as described above in connection with FIGS. 4-7.

Process 800 may include additional aspects, such as any single aspect or any combination of aspects described below and/or in connection with one or more other processes described elsewhere herein.

In a first aspect, the PCI is one of a serving PCI, an active additional PCI, or an inactive additional PCI.

In a second aspect, alone or in combination with the first aspect, the serving PCI and the active additional PCI are associated with different CORESET pool indexes.

In a third aspect, alone or in combination with one or more of the first and second aspects, the CFRA configuration configures the UE to identify an error case when the PDCCH order associated with the first CORESET pool index indicates a PRACH communication toward one of an active additional PCI associated with the second CORESET pool index or an inactive additional PCI.

In a fourth aspect, alone or in combination with one or more of the first through third aspects, the CFRA configuration prohibits monitoring of PDCCH candidates for a type-1 PDCCH common search space when an active TCI state for a CORESET associated with the type-1 PDCCH common search space is not associated with a serving PCI.

In a fifth aspect, alone or in combination with one or more of the first through fourth aspects, receiving the RAR communication includes receiving DCI scrambled by a RA-RNTI.

In a sixth aspect, alone or in combination with one or more of the first through fifth aspects, the CFRA configuration configures the UE to identify an error case when the PDCCH order is associated with the first CORESET pool index and the DCI scrambled by RA-RNTI is associated with the second CORESET pool index different from the first CORESET pool index.

In a seventh aspect, alone or in combination with one or more of the first through sixth aspects, the CFRA configuration is based, at least in part, on the PCI being one of a serving PCI, an active additional PCI, or an inactive additional PCI.

In an eighth aspect, alone or in combination with one or more of the first through seventh aspects, the PCI is an active additional PCI and the PRACH communication is triggered by the PDCCH order, wherein the PDCCH order is associated with the first CORESET pool index, and wherein the RAR communication is associated with the second CORESET pool index.

In a ninth aspect, alone or in combination with one or more of the first through eighth aspects, the PRACH communication is triggered by the PDCCH order, wherein the PDCCH order is associated with the first CORESET pool index, and wherein the PRACH communication is transmitted toward an active additional PCI associated with the second CORESET pool index.

In a tenth aspect, alone or in combination with one or more of the first through ninth aspects, the CFRA configuration configures the UE to monitor PDCCH candidates for a type 1 PDCCH common search space set when an active TCI state for a corresponding CORESET is associated with an active additional PCI.

In an eleventh aspect, alone or in combination with one or more of the first through tenth aspects, the CFRA configuration configures the UE to receive the PDCCH order associated with a CORESET pool index to trigger the PRACH communication toward an inactive additional PCI.

In a twelfth aspect, alone or in combination with one or more of the first through eleventh aspects, the CFRA configuration configures the UE to ignore PDCCH candidates for a type 1 PDCCH common search space set when an active TCI state for a corresponding CORESET pool index is associated with an active additional PCI.

In a thirteenth aspect, alone or in combination with one or more of the first through twelfth aspects, the PDCCH order is associated with the first CORESET pool index that triggers the PRACH communication as a result of the PCI being a serving PCI associated with the first CORESET pool index.

In a fourteenth aspect, alone or in combination with one or more of the first through thirteenth aspects, the PDCCH order is associated with the first CORESET pool index that triggers the PRACH communication as a result of the PCI being an active additional PCI associated with the first CORESET pool index or the second CORESET pool index.

In a fifteenth aspect, alone or in combination with one or more of the first through fourteenth aspects, the PDCCH order is associated with the first CORESET pool index that triggers the PRACH communication as a result of the PCI being an inactive additional PCI.

In a sixteenth aspect, alone or in combination with one or more of the first through fifteenth aspects, the PDCCH order is associated with the first CORESET pool index that triggers the PRACH communication toward an active additional PCI associated with the second CORESET pool index, wherein a transmission power of the PRACH communication is determined based, at least in part, on a downlink reference signal of an active transmission configuration indication state having a lowest identification associated with the second CORESET pool index.

In a seventeenth aspect, alone or in combination with one or more of the first through sixteenth aspects, the PDCCH order is associated with the first CORESET pool index that triggers the PRACH communication toward an active additional PCI associated with the second CORESET pool index, wherein a transmission power of PRACH communication is determined based, at least in part, on a downlink reference signal quasi co-located with a CORESET having the lowest CORESET ID among the CORESETs associated with the second CORESET pool index.

In an eighteenth aspect, alone or in combination with one or more of the first through seventeenth aspects, the PDCCH order is associated with the first CORESET pool index that triggers the PRACH communication toward an active additional PCI associated with the second CORESET pool index, wherein a transmission power of PRACH communication is determined based, at least in part, on a latest indicated transmission control indication state associated with the second CORESET pool index.

In a nineteenth aspect, alone or in combination with one or more of the first through eighteenth aspects, the PDCCH order is associated with the first CORESET pool index that triggers the PRACH communication toward an active additional PCI associated with the second CORESET pool index, wherein a transmission power of the PRACH communication is determined based, at least in part, on a path loss reference signal for a PUCCH resource having a lowest identification associated with the second CORESET pool index.

In a twentieth aspect, alone or in combination with one or more of the first through nineteenth aspects, the PDCCH order is associated with the first CORESET pool index that triggers the PRACH communication toward an active additional PCI associated with the second CORESET pool index, wherein a transmission power of the PRACH communication is determined based, at least in part, on a synchronization signal block associated with the PRACH communication wherein the SSB is indicated by an SSB index field in the PDCCH order.

In a twenty-first aspect, alone or in combination with one or more of the first through twentieth aspects, the PDCCH order is associated with the first CORESET pool index that triggers the PRACH communication toward an active additional PCI associated with the second CORESET pool index, wherein a transmission power of the PRACH communication is determined based, at least in part, on a downlink reference signal that is quasi co-located with a synchronization signal block associated with the PRACH communication wherein the SSB is indicated by an SSB index field in the PDCCH order.

In a twenty-second aspect, alone or in combination with one or more of the first through twenty-first aspects, the PDCCH order is associated with the first CORESET pool index that triggers the PRACH communication toward an inactive additional PCI, wherein a transmission power of the PRACH communication is determined based, at least in part, on a synchronization signal block configured for a layer 1 reference signal received power measurement and associated with the inactive additional PCI.

In a twenty-third aspect, alone or in combination with one or more of the first through twenty-second aspects, the PDCCH order is associated with the first CORESET pool index that triggers the PRACH communication toward an inactive additional PCI, wherein a transmission power of the PRACH communication is determined based, at least in part, on an SSB associated with the PRACH communication, wherein the SSB is indicated by an SSB index field in the PDCCH order.

In a twenty-fourth aspect, alone or in combination with one or more of the first through twenty-third aspects, the PDCCH order is associated with the first CORESET pool index that triggers the PRACH communication toward an inactive additional PCI, wherein a transmission power of the PRACH communication is determined based, at least in part, on a downlink reference signal that is quasi co-located with an SSB associated with the PRACH communication and wherein the SSB is indicated by an SSB index field in the PDCCH order.

In a twenty-fifth aspect, alone or in combination with one or more of the first through twenty-fourth aspects, the PDCCH order is associated with the first CORESET pool index that triggers the PRACH communication toward an inactive additional PCI, wherein a transmission power of the PRACH communication is determined based, at least in part, on a downlink reference signal with an additional offset, wherein the downlink reference signal is a downlink reference signal quasi co-located with a demodulation reference signal of the PDCCH order.

In a twenty-sixth aspect, alone or in combination with one or more of the first through twenty-fifth aspects, the PDCCH order is associated with the first CORESET pool index that triggers the PRACH communication toward an active additional PCI, wherein the CFRA configuration configures the UE to monitor the RAR communication from a serving PCI associated with the second CORESET pool index, and wherein the CFRA configuration configures the UE to determine DMRS antenna port QCL properties for the PDCCH scrambled by RA-RNTI or a PDSCH communication scheduled by the PDCCH scrambled by RA-RNTI based, at least in part, on the DL-RS of an active TCI state of the CORESET with a lowest ID among CORESETs associated with the second CORESET pool index, the DL-RS of the active TCI state with the lowest TCI state ID associated with the second CORESET Pool index, or the DL-RS of a latest indicated TCI state associated with the second CORESET pool index.

In a twenty-seventh aspect, alone or in combination with one or more of the first through twenty-sixth aspects, the PRACH communication is transmitted on an SpCell.

In a twenty-eighth aspect, alone or in combination with one or more of the first through twenty-seventh aspects, the PRACH communication is transmitted on an SCell.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with CFRA for inter-cell mTRP communications.

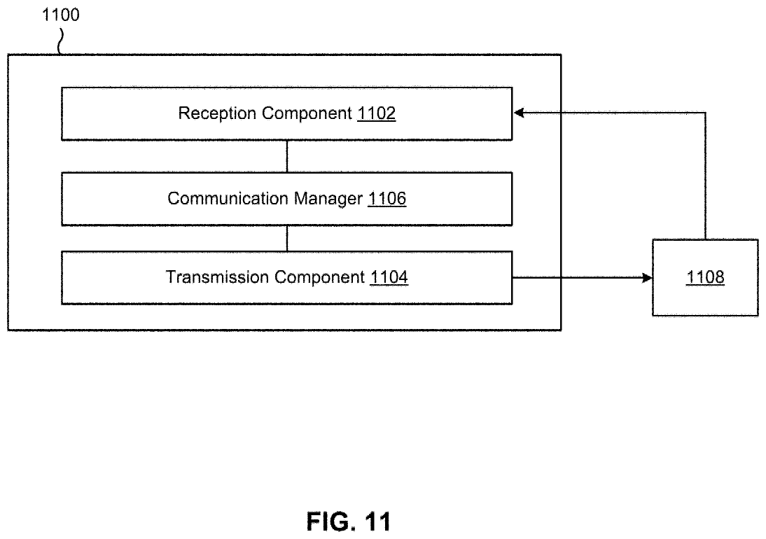

As shown in FIG. 9, in some aspects, process 900 may include outputting or configuring a PDCCH order indicating a CFRA configuration associated with a PCI for a PRACH communication (block 910). For example, the network node (e.g., using transmission component 1104 and/or communication manager 1106, depicted in FIG. 11) may output or configure a PDCCH order indicating a CFRA configuration associated with a PCI for a PRACH communication, as described above in connection with FIGS. 4-7.

As further shown in FIG. 9, in some aspects, process 900 may include configuring a UE to receive a RAR communication associated with a first CORESET pool index or a second CORESET pool index different from the first CORESET pool index responsive to a PRACH communication (block 920). For example, the network node (e.g., using communication manager 1106, depicted in FIG. 11) may configure a UE to receive a RAR communication associated with a first CORESET pool index or a second CORESET pool index different from the first CORESET pool index responsive to a PRACH communication, as described above in connection with FIGS. 4-7.

Process 900 may include additional aspects, such as any single aspect or any combination of aspects described below and/or in connection with one or more other processes described elsewhere herein.

In a first aspect, the PCI is one of a serving PCI, an active additional PCI, or an inactive additional PCI.

In a second aspect, alone or in combination with the first aspect, the serving PCI and the active additional PCI are associated with different CORESET pool indexes.

In a third aspect, alone or in combination with one or more of the first and second aspects, the CFRA configuration configures the UE to identify an error case when the PDCCH order associated with the first CORESET pool index indicates the PRACH communication toward one of an active additional PCI associated with the second CORESET pool index or an inactive additional PCI.

In a fourth aspect, alone or in combination with one or more of the first through third aspects, the CFRA configuration prohibits monitoring of PDCCH candidates for a type-1 PDCCH common search space when an active TCI state for a CORESET associated with the type-1 PDCCH common search space is not associated with a serving PCI.

In a fifth aspect, alone or in combination with one or more of the first through fourth aspects, outputting or configuring the RAR communication includes outputting or configuring DCI scrambled by a RA-RNTI.

In a sixth aspect, alone or in combination with one or more of the first through fifth aspects, the CFRA configuration configures the UE to identify an error case when the PDCCH order is associated with the first CORESET pool index and the DCI scrambled by RA-RNTI is associated with the second CORESET pool index different from the first CORESET pool index.

In a seventh aspect, alone or in combination with one or more of the first through sixth aspects, the CFRA configuration is based, at least in part, on the PCI being one of a serving PCI, an active additional PCI, or an inactive additional PCI.

In an eighth aspect, alone or in combination with one or more of the first through seventh aspects, the PCI is an active additional PCI and the PRACH communication is triggered by the PDCCH order, and wherein the PDCCH order is associated with the first CORESET pool index, the method further comprising outputting or configuring an RAR communication, wherein the RAR communication is associated with the second CORESET pool index.

In a ninth aspect, alone or in combination with one or more of the first through eighth aspects, the PRACH communication is triggered by the PDCCH order, wherein the PDCCH order is associated with the first CORESET pool index, and wherein the PRACH communication is transmitted toward an active additional PCI associated with the second CORESET pool index.

In a tenth aspect, alone or in combination with one or more of the first through ninth aspects, the CFRA configuration configures the UE to monitor PDCCH candidates for a type 1 PDCCH common search space set when an active TCI state for a corresponding CORESET is associated with an active additional PCI.

In an eleventh aspect, alone or in combination with one or more of the first through tenth aspects, the CFRA configuration configures the UE to receive the PDCCH order associated with a CORESET pool index to trigger the PRACH communication toward an inactive additional PCI.

In a twelfth aspect, alone or in combination with one or more of the first through eleventh aspects, the CFRA configuration configures the UE to ignore PDCCH candidates for a type 1 PDCCH common search space set when an active TCI state for a corresponding CORESET pool index is associated with an active additional PCI.

In a thirteenth aspect, alone or in combination with one or more of the first through twelfth aspects, the PDCCH order is associated with the first CORESET pool index that triggers the PRACH communication as a result of the PCI being a serving PCI associated with the first CORESET pool index.

In a fourteenth aspect, alone or in combination with one or more of the first through thirteenth aspects, the PDCCH order is associated with the first CORESET pool index that triggers the PRACH communication as a result of the PCI being an active additional PCI associated with the first CORESET pool index or the second CORESET pool index.

In a fifteenth aspect, alone or in combination with one or more of the first through fourteenth aspects, the PDCCH order is associated with the first CORESET pool index that triggers the PRACH communication as a result of the PCI being an inactive additional PCI.

In a sixteenth aspect, alone or in combination with one or more of the first through fifteenth aspects, the PDCCH order is associated with the first CORESET pool index that triggers the PRACH communication toward an active additional PCI associated with the second CORESET pool index, wherein a transmission power of the PRACH communication is determined based, at least in part, on a downlink reference signal of an active transmission configuration indication state having a lowest identification associated with the second CORESET pool index.

In a seventeenth aspect, alone or in combination with one or more of the first through sixteenth aspects, the PDCCH order is associated with the first CORESET pool index that triggers the PRACH communication toward an active additional PCI associated with the second CORESET pool index, wherein a transmission power of PRACH communication is determined based, at least in part, on a downlink reference signal quasi co-located with a CORESET having the lowest CORESET ID among CORESETs associated with the second CORESET pool index.

In an eighteenth aspect, alone or in combination with one or more of the first through seventeenth aspects, the PDCCH order is associated with the first CORESET pool index that triggers the PRACH communication toward an active additional PCI associated with the second CORESET pool index, wherein a transmission power of PRACH communication is determined based, at least in part, on a latest indicated transmission control indication state associated with the second CORESET pool index.

In a nineteenth aspect, alone or in combination with one or more of the first through eighteenth aspects, the PDCCH order is associated with the first CORESET pool index that triggers the PRACH communication toward an active additional PCI associated with the second CORESET pool index, wherein a transmission power of the PRACH communication is determined based, at least in part, on a path loss reference signal for a PUCCH resource having a lowest identification associated with the second CORESET pool index.

In a twentieth aspect, alone or in combination with one or more of the first through nineteenth aspects, the PDCCH order is associated with the first CORESET pool index that triggers the PRACH communication toward an active additional PCI associated with the second CORESET pool index, wherein a transmission power of the PRACH communication is determined based, at least in part, on a synchronization signal block associated with the PRACH communication wherein the SSB is indicated by an SSB index field in the PDCCH order.

In a twenty-first aspect, alone or in combination with one or more of the first through twentieth aspects, the PDCCH order is associated with the first CORESET pool index that triggers the PRACH communication toward an active additional PCI associated with the second CORESET pool index, wherein a transmission power of the PRACH communication is determined based, at least in part, on a downlink reference signal that is quasi co-located with a synchronization signal block associated with the PRACH communication wherein the SSB is indicated by an SSB index field in the PDCCH order.

In a twenty-second aspect, alone or in combination with one or more of the first through twenty-first aspects, the PDCCH order is associated with the first CORESET pool index that triggers the PRACH communication toward an inactive additional PCI, wherein a transmission power of the PRACH communication is determined based, at least in part, on a synchronization signal block configured for a layer 1 reference signal received power measurement and associated with the inactive additional PCI.

In a twenty-third aspect, alone or in combination with one or more of the first through twenty-second aspects, the PDCCH order is associated with the first CORESET pool index that triggers the PRACH communication toward an inactive additional PCI, wherein a transmission power of the PRACH communication is determined based, at least in part, on an SSB associated with the PRACH communication, wherein the SSB is indicated by an SSB index field in the PDCCH order.

In a twenty-fourth aspect, alone or in combination with one or more of the first through twenty-third aspects, the PDCCH order is associated with the first CORESET pool index that triggers the PRACH communication toward an inactive additional PCI, wherein a transmission power of the PRACH communication is determined based, at least in part, on a downlink reference signal that is quasi co-located with an SSB associated with the PRACH communication and wherein the SSB is indicated by an SSB index field in the PDCCH order.

In a twenty-fifth aspect, alone or in combination with one or more of the first through twenty-fourth aspects, the PDCCH order is associated with the first CORESET pool index that triggers the PRACH communication toward an inactive additional PCI, wherein a transmission power of the PRACH communication is determined based, at least in part, on a downlink reference signal with an additional offset, wherein the downlink reference signal is a downlink reference signal quasi co-located with a demodulation reference signal of the PDCCH order.

In a twenty-sixth aspect, alone or in combination with one or more of the first through twenty-fifth aspects, the PDCCH order is associated with the first CORESET pool index that triggers the PRACH communication toward an active additional PCI, wherein the CFRA configuration configures the UE to monitor the RAR communication from a serving PCI associated with the second CORESET pool index, and wherein the CFRA configuration configures the UE to determine DMRS antenna port QCL properties for the PDCCH scrambled by RA-RNTI or a PDSCH communication scheduled by the PDCCH scrambled by RA-RNTI based, at least in part, on the DL-RS of an active TCI state of the CORESET with a lowest ID among CORESETs associated with the second CORESET pool index, the DL-RS of the active TCI state with the lowest TCI state ID associated with the second CORESET Pool index, or the DL-RS of a latest indicated TCI state associated with the second CORESET pool index.

In a twenty-seventh aspect, alone or in combination with one or more of the first through twenty-sixth aspects, the PRACH communication is transmitted on a special cell.

In a twenty-eighth aspect, alone or in combination with one or more of the first through twenty-seventh aspects, the PRACH communication is transmitted on a secondary cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a PDCCH order associated with a first CORESET pool index indicating a CFRA configuration associated with a PCI. The transmission component 1004 may transmit the PRACH communication toward the PCI in accordance with the CFRA configuration. The reception component 1002 may receive a RAR communication associated with the first CORESET pool index or a second CORESET pool index different from the first CORESET pool index responsive to the PRACH communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may output or configure a PDCCH order indicating a CFRA configuration associated with a PCI for a PRACH communication. The communication manager 1106 may configure a UE to receive a RAR communication associated with a first CORESET pool index or a second CORESET pool index different from the first CORESET pool index responsive to a PRACH communication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving a PDCCH order associated with a first CORESET pool index indicating a CFRA configuration associated with a PCI; transmitting a PRACH communication toward the PCI in accordance with the CFRA configuration; and receiving a RAR communication associated with the first CORESET pool index or a second CORESET pool index different from the first CORESET pool index responsive to the PRACH communication.

Aspect 2: The method of Aspect 1, wherein the PCI is one of a serving PCI, an active additional PCI, or an inactive additional PCI.

Aspect 3: The method of Aspect 2, wherein the serving PCI and the active additional PCI are associated with different CORESET pool indexes.

Aspect 4: The method of any of Aspects 1-3, wherein the CFRA configuration configures the UE to identify an error case when the PDCCH order associated with the first CORESET pool index indicates the PRACH communication toward one of an active additional PCI associated with the second CORESET pool index or an inactive additional PCI.

Aspect 5: The method of any of Aspects 1-4, wherein the CFRA configuration prohibits monitoring of PDCCH candidates for a type-1 PDCCH common search space when an active TCI state for a CORESET associated with the type-1 PDCCH common search space is not associated with a serving PCI.

Aspect 6: The method of any of Aspects 1-5, wherein receiving the RAR communication includes receiving DCI scrambled by a RA-RNTI.

Aspect 7: The method of Aspect 6, wherein the CFRA configuration configures the UE to identify an error case when the PDCCH order is associated with the first CORESET pool index and the DCI scrambled by RA-RNTI is associated with the second CORESET pool index different from the first CORESET pool index.

Aspect 8: The method of any of Aspects 1-7, wherein the CFRA configuration is based, at least in part, on the PCI being one of a serving PCI, an active additional PCI, or an inactive additional PCI.

Aspect 9: The method of any of Aspects 1-8, wherein the PCI is an active additional PCI and the PRACH communication is triggered by the PDCCH order, wherein the PDCCH order is associated with the first CORESET pool index, and wherein the RAR communication is associated with the second CORESET pool index.

Aspect 10: The method of any of Aspects 1-9, wherein the PRACH communication is triggered by the PDCCH order, wherein the PDCCH order is associated with the first CORESET pool index, and wherein the PRACH communication is transmitted toward an active additional PCI associated with the second CORESET pool index.

Aspect 11: The method of any of Aspects 1-10, wherein the CFRA configuration configures the UE to monitor PDCCH candidates for a type 1 PDCCH common search space set when an active transmission configuration indication (TCI) state for a corresponding CORESET is associated with an active additional PCI.

Aspect 12: The method of any of Aspects 1-11, wherein the CFRA configuration configures the UE to receive the PDCCH order associated with a CORESET pool index to trigger the PRACH communication toward an inactive additional PCI.

Aspect 13: The method of Aspect 12, wherein the CFRA configuration configures the UE to ignore PDCCH candidates for a type 1 PDCCH common search space set when an active TCI state for a corresponding CORESET pool index is associated with an active additional PCI.

Aspect 14: The method of any of Aspects 1-13, wherein the PDCCH order is associated with the first CORESET pool index that triggers the PRACH communication as a result of the PCI being a serving PCI associated with the first CORESET pool index.

Aspect 15: The method of any of Aspects 1-14, wherein the PDCCH order is associated with the first CORESET pool index that triggers the PRACH communication as a result of the PCI being an active additional PCI associated with the first CORESET pool index or the second CORESET pool index.

Aspect 16: The method of any of Aspects 1-15, wherein the PDCCH order is associated with the first CORESET pool index that triggers the PRACH communication as a result of the PCI being an inactive additional PCI.

Aspect 17: The method of any of Aspects 1-16, wherein the PDCCH order is associated with the first CORESET pool index that triggers the PRACH communication toward an active additional PCI associated with the second CORESET pool index, wherein a transmission power of the PRACH communication is determined based, at least in part, on a downlink reference signal of an active transmission configuration indication state having a lowest identification associated with the second CORESET pool index.

Aspect 18: The method of any of Aspects 1-17, wherein the PDCCH order is associated with the first CORESET pool index that triggers the PRACH communication toward an active additional PCI associated with the second CORESET pool index, wherein a transmission power of PRACH communication is determined based, at least in part, on a downlink reference signal quasi co-located with a CORESET having the lowest CORESET ID among the CORESETs associated with the second CORESET pool index.

Aspect 19: The method of any of Aspects 1-18, wherein the PDCCH order is associated with the first CORESET pool index that triggers the PRACH communication toward an active additional PCI associated with the second CORESET pool index, wherein a transmission power of PRACH communication is determined based, at least in part, on a latest indicated transmission control indication state associated with the second CORESET pool index.

Aspect 20: The method of any of Aspects 1-19, wherein the PDCCH order is associated with the first CORESET pool index that triggers the PRACH communication toward an active additional PCI associated with the second CORESET pool index, wherein a transmission power of the PRACH communication is determined based, at least in part, on a path loss reference signal for a physical uplink control channel (PUCCH) resource having a lowest identification associated with the second CORESET pool index.

Aspect 21: The method of any of Aspects 1-20, wherein the PDCCH order is associated with the first CORESET pool index that triggers the PRACH communication toward an active additional PCI associated with the second CORESET pool index, wherein a transmission power of the PRACH communication is determined based, at least in part, on a synchronization signal block associated with the PRACH communication wherein the SSB is indicated by an SSB index field in the PDCCH order.

Aspect 22: The method of any of Aspects 1-21, wherein the PDCCH order is associated with the first CORESET pool index that triggers the PRACH communication toward an active additional PCI associated with the second CORESET pool index, wherein a transmission power of the PRACH communication is determined based, at least in part, on a downlink reference signal that is quasi co-located with a synchronization signal block associated with the PRACH communication wherein the SSB is indicated by an SSB index field in the PDCCH order.

Aspect 23: The method of any of Aspects 1-22, wherein the PDCCH order is associated with the first CORESET pool index that triggers the PRACH communication toward an inactive additional PCI, wherein a transmission power of the PRACH communication is determined based, at least in part, on a synchronization signal block configured for a layer 1 reference signal received power measurement and associated with the inactive additional PCI.

Aspect 24: The method of any of Aspects 1-23, wherein the PDCCH order is associated with the first CORESET pool index that triggers the PRACH communication toward an inactive additional PCI, wherein a transmission power of the PRACH communication is determined based, at least in part, on a synchronization signal block (SSB) associated with the PRACH communication, wherein the SSB is indicated by an SSB index field in the PDCCH order.

Aspect 25: The method of any of Aspects 1-24, wherein the PDCCH order is associated with the first CORESET pool index that triggers the PRACH communication toward an inactive additional PCI, wherein a transmission power of the PRACH communication is determined based, at least in part, on a downlink reference signal that is quasi co-located with a synchronization signal block (SSB) associated with the PRACH communication and wherein the SSB is indicated by an SSB index field in the PDCCH order.

Aspect 26: The method of any of Aspects 1-25, wherein the PDCCH order is associated with the first CORESET pool index that triggers the PRACH communication toward an inactive additional PCI, wherein a transmission power of the PRACH communication is determined based, at least in part, on a downlink reference signal with an additional offset, wherein the downlink reference signal is a downlink reference signal quasi co-located with a demodulation reference signal of the PDCCH order.

Aspect 27: The method of any of Aspects 1-26, wherein the PDCCH order is associated with the first CORESET pool index that triggers the PRACH communication toward an active additional PCI, wherein the CFRA configuration configures the UE to monitor the RAR communication from a serving PCI associated with the second CORESET pool index, and wherein the CFRA configuration configures the UE to determine DMRS antenna port QCL properties for the PDCCH scrambled by RA-RNTI or a PDSCH communication scheduled by the PDCCH scrambled by RA-RNTI based, at least in part, on: the DL-RS of an active TCI state of the CORESET with a lowest ID among CORESETs associated with the second CORESET pool index; the DL-RS of the active TCI state with the lowest TCI state ID associated with the second CORESET Pool index; or the DL-RS of a latest indicated TCI state associated with the second CORESET pool index.

Aspect 28: The method of any of Aspects 1-27, wherein the PRACH communication is transmitted on an SpCell.

Aspect 29: The method of any of Aspects 1-28, wherein the PRACH communication is transmitted on an SCell.

Aspect 30: A method of wireless communication performed by a network node, comprising: outputting or configuring a PDCCH order indicating a CFRA configuration associated with a PCI for a PRACH communication; and configuring a UE to receive a RAR communication associated with a first CORESET pool index or a second CORESET pool index different from the first CORESET pool index responsive to a PRACH communication.

Aspect 31: The method of Aspect 30, wherein the PCI is one of a serving PCI, an active additional PCI, or an inactive additional PCI.

Aspect 32: The method of Aspect 31, wherein the serving PCI and the active additional PCI are associated with different CORESET pool indexes.

Aspect 33: The method of any of Aspects 30-32, wherein the CFRA configuration configures the UE to identify an error case when the PDCCH order associated with the first CORESET pool index indicates the PRACH communication toward one of an active additional PCI associated with the second CORESET pool index or an inactive additional PCI.

Aspect 34: The method of any of Aspects 30-33, wherein the CFRA configuration prohibits monitoring of PDCCH candidates for a type-1 PDCCH common search space when an active transmission configuration indicator (TCI) state for a CORESET associated with the type-1 PDCCH common search space is not associated with a serving PCI.

Aspect 35: The method of any of Aspects 30-34, wherein outputting or configuring the RAR communication includes outputting or configuring DCI scrambled by a RA-RNTI.

Aspect 36: The method of Aspect 35, wherein the CFRA configuration configures the UE to identify an error case when the PDCCH order is associated with the first CORESET pool index and the DCI scrambled by RA-RNTI is associated with the second CORESET pool index different from the first CORESET pool index.

Aspect 37: The method of any of Aspects 30-36, wherein the CFRA configuration is based, at least in part, on the PCI being one of a serving PCI, an active additional PCI, or an inactive additional PCI.

Aspect 38: The method of any of Aspects 30-37, wherein the PCI is an active additional PCI and the PRACH communication is triggered by the PDCCH order, and wherein the PDCCH order is associated with the first CORESET pool index, the method further comprising outputting or configuring an RAR communication, wherein the RAR communication is associated with the second CORESET pool index.

Aspect 39: The method of any of Aspects 30-38, wherein the PRACH communication is triggered by the PDCCH order, wherein the PDCCH order is associated with the first CORESET pool index, and wherein the PRACH communication is transmitted toward an active additional PCI associated with the second CORESET pool index.

Aspect 40: The method of any of Aspects 30-39, wherein the CFRA configuration configures the UE to monitor PDCCH candidates for a type 1 PDCCH common search space set when an active transmission configuration indication (TCI) state for a corresponding CORESET is associated with an active additional PCI.

Aspect 41: The method of any of Aspects 30-40, wherein the CFRA configuration configures the UE to receive the PDCCH order associated with a CORESET pool index to trigger the PRACH communication toward an inactive additional PCI.

Aspect 42: The method of Aspect 41, wherein the CFRA configuration configures the UE to ignore PDCCH candidates for a type 1 PDCCH common search space set when an active TCI state for a corresponding CORESET pool index is associated with an active additional PCI.

Aspect 43: The method of any of Aspects 30-42, wherein the PDCCH order is associated with the first CORESET pool index that triggers the PRACH communication as a result of the PCI being a serving PCI associated with the first CORESET pool index.

Aspect 44: The method of any of Aspects 30-43, wherein the PDCCH order is associated with the first CORESET pool index that triggers the PRACH communication as a result of the PCI being an active additional PCI associated with the first CORESET pool index or the second CORESET pool index.

Aspect 45: The method of any of Aspects 30-44, wherein the PDCCH order is associated with the first CORESET pool index that triggers the PRACH communication as a result of the PCI being an inactive additional PCI.

Aspect 46: The method of any of Aspects 30-45, wherein the PDCCH order is associated with the first CORESET pool index that triggers the PRACH communication toward an active additional PCI associated with the second CORESET pool index, wherein a transmission power of the PRACH communication is determined based, at least in part, on a downlink reference signal of an active transmission configuration indication state having a lowest identification associated with the second CORESET pool index.

Aspect 47: The method of any of Aspects 30-46, wherein the PDCCH order is associated with the first CORESET pool index that triggers the PRACH communication toward an active additional PCI associated with the second CORESET pool index, wherein a transmission power of PRACH communication is determined based, at least in part, on a downlink reference signal quasi co-located with a CORESET having the lowest CORESET ID among CORESETs associated with the second CORESET pool index.

Aspect 48: The method of any of Aspects 30-47, wherein the PDCCH order is associated with the first CORESET pool index that triggers the PRACH communication toward an active additional PCI associated with the second CORESET pool index, wherein a transmission power of PRACH communication is determined based, at least in part, on a latest indicated transmission control indication state associated with the second CORESET pool index.

Aspect 49: The method of any of Aspects 30-48, wherein the PDCCH order is associated with the first CORESET pool index that triggers the PRACH communication toward an active additional PCI associated with the second CORESET pool index, wherein a transmission power of the PRACH communication is determined based, at least in part, on a path loss reference signal for a physical uplink control channel (PUCCH) resource having a lowest identification associated with the second CORESET pool index.

Aspect 50: The method of any of Aspects 30-49, wherein the PDCCH order is associated with the first CORESET pool index that triggers the PRACH communication toward an active additional PCI associated with the second CORESET pool index, wherein a transmission power of the PRACH communication is determined based, at least in part, on a synchronization signal block associated with the PRACH communication wherein the SSB is indicated by an SSB index field in the PDCCH order.

Aspect 51: The method of any of Aspects 30-50, wherein the PDCCH order is associated with the first CORESET pool index that triggers the PRACH communication toward an active additional PCI associated with the second CORESET pool index, wherein a transmission power of the PRACH communication is determined based, at least in part, on a downlink reference signal that is quasi co-located with a synchronization signal block associated with the PRACH communication wherein the SSB is indicated by an SSB index field in the PDCCH order.

Aspect 52: The method of any of Aspects 30-51, wherein the PDCCH order is associated with the first CORESET pool index that triggers the PRACH communication toward an inactive additional PCI, wherein a transmission power of the PRACH communication is determined based, at least in part, on a synchronization signal block configured for a layer 1 reference signal received power measurement and associated with the inactive additional PCI.

Aspect 53: The method of any of Aspects 30-52, wherein the PDCCH order is associated with the first CORESET pool index that triggers the PRACH communication toward an inactive additional PCI, wherein a transmission power of the PRACH communication is determined based, at least in part, on a synchronization signal block (SSB) associated with the PRACH communication, wherein the SSB is indicated by an SSB index field in the PDCCH order.

Aspect 54: The method of any of Aspects 30-53, wherein the PDCCH order is associated with the first CORESET pool index that triggers the PRACH communication toward an inactive additional PCI, wherein a transmission power of the PRACH communication is determined based, at least in part, on a downlink reference signal that is quasi co-located with an SSB associated with the PRACH communication and wherein the SSB is indicated by an SSB index field in the PDCCH order.

Aspect 55: The method of any of Aspects 30-54, wherein the PDCCH order is associated with the first CORESET pool index that triggers the PRACH communication toward an inactive additional PCI, wherein a transmission power of the PRACH communication is determined based, at least in part, on a downlink reference signal with an additional offset, wherein a downlink reference signal is a downlink reference signal quasi co-located with a demodulation reference signal of the PDCCH order.

Aspect 56: The method of any of Aspects 30-55, wherein the PDCCH order is associated with the first CORESET pool index that triggers the PRACH communication toward an active additional PCI, wherein the CFRA configuration configures the UE to monitor the RAR communication from a serving PCI associated with the second CORESET pool index, and wherein the CFRA configuration configures the UE to determine DMRS antenna port QCL properties for the PDCCH scrambled by RA-RNTI or a PDSCH communication scheduled by the PDCCH scrambled by RA-RNTI based, at least in part, on: a DL-RS of an active TCI state of the CORESET with a lowest ID among CORESETs associated with the second CORESET pool index; the DL-RS of the active TCI state with the lowest TCI state ID associated with the second CORESET Pool index; or the DL-RS of a latest indicated TCI state associated with the second CORESET pool index.

Aspect 57: The method of any of Aspects 30-56, wherein the PRACH communication is transmitted on an SpCell.

Aspect 58: The method of any of Aspects 30-57, wherein the PRACH communication is transmitted on an SCell.

Aspect 59: An apparatus for wireless communication at a device, comprising a processor; memory coupled with the processor; and instructions stored in the memory and executable by the processor to cause the apparatus to perform the method of one or more of Aspects 1-58.

Aspect 60: A device for wireless communication, comprising a memory and one or more processors coupled to the memory, the one or more processors configured to perform the method of one or more of Aspects 1-58.

Aspect 61: An apparatus for wireless communication, comprising at least one means for performing the method of one or more of Aspects 1-58.

Aspect 62: A non-transitory computer-readable medium storing code for wireless communication, the code comprising instructions executable by a processor to perform the method of one or more of Aspects 1-58.

Aspect 63: A non-transitory computer-readable medium storing a set of instructions for wireless communication, the set of instructions comprising one or more instructions that, when executed by one or more processors of a device, cause the device to perform the method of one or more of Aspects 1-58.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a physical downlink control channel (PDCCH) order associated with a first control resource set (CORESET) pool index indicating a contention free random access (CFRA) configuration associated with a physical cell identifier (PCI);
transmit a physical random access channel (PRACH) communication toward the PCI in accordance with the CFRA configuration; and
receive a random access response (RAR) communication associated with the first CORESET pool index or a second CORESET pool index different from the first CORESET pool index responsive to the PRACH communication.

2. (canceled)

3. The UE of claim 1, wherein the CFRA configuration configures the UE to identify an error case when the PDCCH order associated with the first CORESET pool index indicates the PRACH communication toward one of an active additional PCI associated with the second CORESET pool index or an inactive additional PCI.

4. The UE of claim 1, wherein the CFRA configuration prohibits monitoring of PDCCH candidates for a type-1 PDCCH common search space when an active transmission configuration indicator (TCI) state for a CORESET associated with the type-1 PDCCH common search space is not associated with a serving PCI.

5. The UE of claim 1, wherein the CFRA configuration configures the UE to identify an error case when the PDCCH order is associated with the first CORESET pool index and the RAR communication is associated with a second CORESET pool index different from the first CORESET pool index.

6. (canceled)

7. The UE of claim 1, wherein the PCI is an active additional PCI and the PRACH communication is triggered by the PDCCH order, wherein the PDCCH order is associated with the first CORESET pool index, and wherein the RAR communication is associated with the second CORESET pool index.

8. The UE of claim 1, wherein the PRACH communication is triggered by the PDCCH order, wherein the PDCCH order is associated with a first CORESET pool index, and wherein the PRACH communication is transmitted toward an active additional PCI associated with a second CORESET pool index.

9. The UE of claim 1, wherein the CFRA configuration configures the UE to monitor PDCCH candidates for a type 1 PDCCH common search space set when an active transmission configuration indication (TCI) state for a corresponding CORESET is associated with an active additional PCI.

10. The UE of claim 1, wherein the CFRA configuration configures the UE to receive the PDCCH order associated with a CORESET pool index to trigger the PRACH communication toward an inactive additional PCI.

11. The UE of claim 10, wherein the CFRA configuration configures the UE to ignore PDCCH candidates for a type 1 PDCCH common search space set when an active transmission configuration indication (TCI) state for a corresponding CORESET pool index is associated with an active additional PCI.

12. The UE of claim 1, wherein the PDCCH order is associated with a first CORESET pool index that triggers the PRACH communication as a result of the PCI being an active additional PCI associated with the first CORESET pool index or a second CORESET pool index.

13. The UE of claim 1, wherein the PDCCH order is associated with a first control resource set pool index that triggers the PRACH communication as a result of the PCI being an inactive additional PCI.

14. The UE of claim 1, wherein the PDCCH order is associated with the first CORESET pool index that triggers the PRACH communication toward an active additional PCI associated with the second CORESET pool index, wherein a transmission power of the PRACH communication is determined based, at least in part, on a downlink reference signal of an active transmission configuration indication state having a lowest identification associated with the second CORESET pool index.

15. (canceled)

16. The UE of claim 1, wherein the PDCCH order is associated with the first CORESET pool index that triggers the PRACH communication toward an active additional PCI associated with the second CORESET pool index, wherein a transmission power of PRACH communication is determined based, at least in part, on a latest indicated transmission control indication state associated with the second CORESET pool index.

17. The UE of claim 1, wherein the PDCCH order is associated with the first CORESET pool index that triggers the PRACH communication toward an active additional PCI associated with the second CORESET pool index, wherein a transmission power of the PRACH communication is determined based, at least in part, on a path loss reference signal for a physical uplink control channel (PUCCH) resource having a lowest identification associated with the second CORESET pool index.

18. The UE of claim 1, wherein the PDCCH order is associated with the first CORESET pool index that triggers the PRACH communication toward an active additional PCI associated with the second CORESET pool index, wherein a transmission power of the PRACH communication is determined based, at least in part, on one or more of:
a synchronization signal block (SSB) associated with the PRACH communication; or
a downlink reference signal that is quasi co-located with a synchronization signal block associated with the PRACH communication;
wherein the SSB is indicated by an SSB index field in the PDCCH order.

19. The UE of claim 1, wherein the PDCCH order is associated with the first CORESET pool index that triggers the PRACH communication toward an inactive additional PCI, wherein a transmission power of the PRACH communication is determined based, at least in part, on a synchronization signal block configured for a layer 1 reference signal received power measurement and associated with the inactive additional PCI.

20. (canceled)

21. The UE of claim 1, wherein the PDCCH order is associated with the first CORESET pool index that triggers the PRACH communication toward an inactive additional PCI, wherein a transmission power of the PRACH communication is determined based, at least in part, on a downlink reference signal that is quasi co-located with a synchronization signal block (SSB) associated with the PRACH communication and wherein the SSB is indicated by an SSB index field in the PDCCH order.

22. The UE of claim 1, wherein the PDCCH order is associated with the first CORESET pool index that triggers the PRACH communication toward an inactive additional PCI, wherein a transmission power of the PRACH communication is determined based, at least in part, on a downlink reference signal with an additional offset, wherein the downlink reference signal is a downlink reference signal quasi co-located with a demodulation reference signal of the PDCCH order.

23. The UE of claim 1, wherein the PDCCH order is associated with the first CORESET pool index that triggers the PRACH communication toward an active additional PCI, wherein the CFRA configuration configures the UE to monitor the RAR communication from a serving PCI associated with the second CORESET pool index, and wherein the CFRA configuration configures the UE to determine demodulation reference signal (DMRS) antenna port quasi co-location (QCL) properties for the PDCCH scrambled by RA-RNTI or a physical downlink shared channel (PDSCH) communication scheduled by the PDCCH scrambled by RA-RNTI based, at least in part, on:
the downlink reference signal (DL-RS) of an active transmission configuration indicator (TCI) state of the CORESET with a lowest ID among CORESETs associated with the second CORESET pool index;
the DL-RS of the active TCI state with the lowest TCI state ID associated with the second CORESET Pool index; or
the DL-RS of a latest indicated TCI state associated with the second CORESET pool index.

24-26. (canceled)

27. A method of wireless communication performed by a user equipment (UE), comprising:
receiving a physical downlink control channel (PDCCH) order associated with a first control resource set (CORESET) pool index indicating a contention free random access (CFRA) configuration associated with a physical cell identifier (PCI);
transmitting a physical random access channel (PRACH) communication toward the PCI in accordance with the CFRA configuration; and
receiving a random access response (RAR) communication associated with the first CORESET pool index or a second CORESET pool index different from the first CORESET pool index responsive to the PRACH communication.

28-30. (canceled)
